(19) United States
(12) Patent Application Publication
(10) Pub. No.: US 2025/0291357 A1
(43) Pub. Date: Sep. 18, 2025

(54) TERRAIN COMPLIANT ROBOT LOCOMOTION MECHANISM

(71) Applicant: Dubai Future Foundation, Dubai (AE)

(72) Inventors: Layth Mahdi, Dubai (AE); Tanzim Ahmed, Dubai (AE)

(73) Assignee: Dubai Future Foundation, Dubai (AE)

(21) Appl. No.: 19/079,952

(22) Filed: Mar. 14, 2025

Related U.S. Application Data
(60) Provisional application No. 63/565,894, filed on Mar. 15, 2024.

(51) Int. Cl. G05D 1/628; G05D 109/15

(52) U.S. Cl. CPC G05D 1/628; G05D 2109/15

(57) ABSTRACT

A mobile robot with a locomotion mechanism is described which is adapted to traverse vertical obstacles. The mobile robot includes a frame structure and a wheel assembly including at least two back wheels, at least two middle wheels, and at least two front wheels. The mobile robot further includes a first and a second front rocker arms arranged on opposing sides of the frame structure each coupled to the frame structure. Each of the first and second front rocker arms is pivotable around a lever bearing located between respective axial centers of rotation of wheel pairs.

### CROSS-REFERENCE TO RELATED APPLICATIONS

This application claims the benefit of U.S. Provisional Patent Application Ser. No. 63/565,894, filed Mar. 15, 2024, entitled “TERRAIN COMPLIANT ROBOT LOCOMOTION MECHANISM”, the content of which is incorporated herein by reference in its entirety.

### TECHNICAL FIELD

The present description relates to a mobile robot system and, more particularly, to a mobile robot system including a locomotion mechanism.

### BACKGROUND

Mobile robots, particularly autonomous mobile robots, have a wide range of applications, and are increasingly deployed in a variety of environments with diverse terrains.

Even though many of the applications of these mobile robots assume that the robots will operate on a flat terrain, in many cases, the mobile robot often needs to be able to deal with a certain variation of the terrain. However, unlike humans, sharp vertical terrain elevations, such as steps, ledges, or curbs, pose a substantial challenge for conventional mobile robots. These obstacles hinder the robot's mobility, limit its access to different environments, and can potentially result in the robot becoming stuck or unable to proceed further.

There is therefore a need to provide a better or alternative solution for a mobile robot system in the presence of terrain fluctuation, and particularly over vertical obstacles.

### SUMMARY

The following presents a summary of some aspects or embodiments of the disclosure in order to provide a basic understanding of the disclosure. This summary is not an extensive overview of the disclosure. It is not intended to identify key or critical elements of the disclosure or to delineate the scope of the disclosure. Its sole purpose is to present some embodiments of the disclosure in a simplified form as a prelude to the more detailed description that is presented later.

In accordance with one aspect of the present disclosure, a mobile robot is described which is adapted to traverse at least one vertical obstacle. The mobile robot comprises a frame structure having a front section, a middle section, and a rear section; at least two back wheels positioned in the rear section of the frame structure, at least two middle wheels positioned in the middle section of the frame structure, at least two front wheels positioned in the front section of the frame structure; and a first and a second front rocking arms arranged on opposing sides of the frame structure each pivotably coupled to the frame structure. The first and second front rocking arms each interconnects one middle wheel and one front wheel, forming a first wheel pair and a second wheel pair. Each of the first and second front rocking arms is pivotable around respective axial centers of rotation of the first and second wheel pairs.

In some embodiments, the first and the second front rocker arms are pivotable independently of each other.

In some embodiments, each of the first and second front rocking arms is pivotable around a lever bearing located between the respective axial centers of rotation of the first and second wheel pairs.

In some embodiments, the mobile robot further comprises a locking mechanism for restricting a rotation of each of the first and second front rocker arms.

In some embodiments, each of the first and second front rocking arms is adapted to rotate around the lever bearing by at most 20° clock or counter-clock wise.

In some embodiments, the mobile robot further comprises one or more motors driving one or more of the front, middle and back wheels.

In some embodiments, the one or more motors are adapted to facilitate traversing of the at least one vertical obstacle upon a detection of pivot of the first and second front rocker arms.

In accordance with another aspect of the present disclosure, a method is described which comprises providing a mobile robot comprising a frame structure and a wheel assembly including at least two back wheels, at least two middle wheels, and at least two front wheels; connecting a first middle wheel and a first front wheel by a first front rocking arm, forming a first wheel pair; connecting a second middle wheel and a second front wheel by a second front rocking arm, forming a second wheel pair; arranging the first and the second front rocking arms on opposing sides of the frame structure and pivotably coupling each of the first and the second front rocking arms to the frame structure, and when traversing a vertical obstacle pivoting the first and second front rocking arms around respective axial centers of rotation of the first and second wheel pairs.

In some embodiments, pivoting the first and second front rocking arms comprises independently pivoting the first and second front rocking arms.

In some embodiments, the method further comprises positioning a first and second lever bearings between the respective axial centers of rotation of the first and second wheel pairs on opposing sides.

In some embodiments, the method further comprises restricting a rotation of each of the first and second front rocking arms by a locking mechanism.

In some embodiments, pivoting the first and second front rocking arms comprises pivoting each of the first and second front rocking arms by at most 20° clock or counter-clock wise.

In some embodiments, the method further comprises driving one or more of the front, middle and back wheels by one or more motors.

In some embodiments, the method further comprises controlling the one or more motors to facilitate traversing of a vertical obstacle upon a detection of pivot of the first and second front rocking arms.

### BRIEF DESCRIPTION OF THE DRAWINGS

These and other features of the disclosure will become more apparent from the description in which reference is made to the following appended drawings.

FIG. 1 is a side elevation view of a mobile robot according to one embodiment of the description;

FIG. 2 is a schematic illustration depicting the relationships between the distances and angles between the front, middle, and rear wheels;

FIG. 3 is a side elevation view of a mobile robot climbing an obstacle with front wheels, according to one embodiment of the description;

FIG. 4 is a side elevation view of a mobile robot climbing an obstacle with middle wheels, according to one embodiment of the description;

FIG. 5 is a side elevation view of a robot platform climbing an obstacle with back wheels, according to one embodiment of the description;

FIG. 6 is a side elevation view of a mobile robot climbing two obstacles, according to one embodiment of the description;

FIG. 7 is a front perspective view of a mobile robot pivoting the left and right side front rocker arms independently, according to one embodiment of the description;

FIG. 8(A) is a side elevation view of a mobile robot with a back rocker arm climbing an obstacle;

FIG. 8(B) is a side elevation view of a mobile robot with a front rocker arm climbing an obstacle;

FIG. 9 is a side elevation view of the rocker arm assembly, according to one embodiment of the description; and

FIG. 10 is a flowchart of a method according to one embodiment of the description.

### DETAILED DESCRIPTION

The following detailed description contains, for the purposes of explanation, various illustrative embodiments, implementations, examples and specific details in order to provide a thorough understanding of the disclosure. It is apparent, however, that the disclosed embodiments may be practiced, in some instances, without these specific details or with an equivalent arrangement. The description should in no way be limited to the illustrative implementations, drawings, and techniques illustrated below, including the exemplary designs and implementations illustrated and described herein, but may be modified within the scope of the appended claims along with their full scope of equivalents.

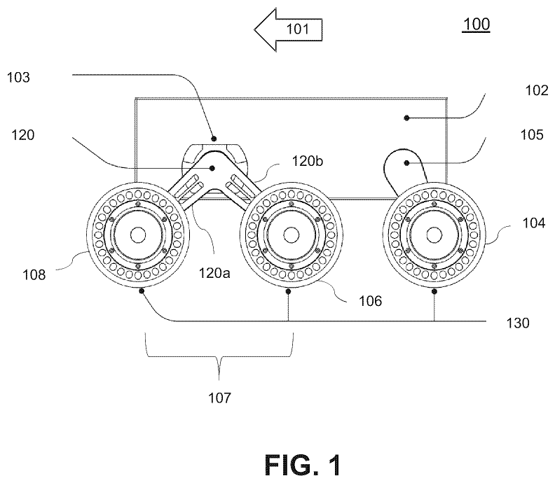

Embodiments are described below, by way of example only, with reference to FIGS. 1-10. Reference numerals have been referred to facilitate understanding and are not intended to limit the scope of the present invention in any manner.

Described herein includes a mobile robot adapted to traverse vertical obstacles such as steps, ledges, or curbs and the like with a locomotion mechanism. The described mobile robot according to various embodiments can enable a more stable support and/or stable motion of the mobile robot in the presence of terrain fluctuation, and particularly over vertical obstacles.

FIG. 1 shows one embodiment of a mobile robot or vehicle 100 in accordance with the description. The mobile robot 100 comprises a frame structure 102 and a six-wheel assembly that include rear wheels 104, middle wheels 106, and front wheels 108.

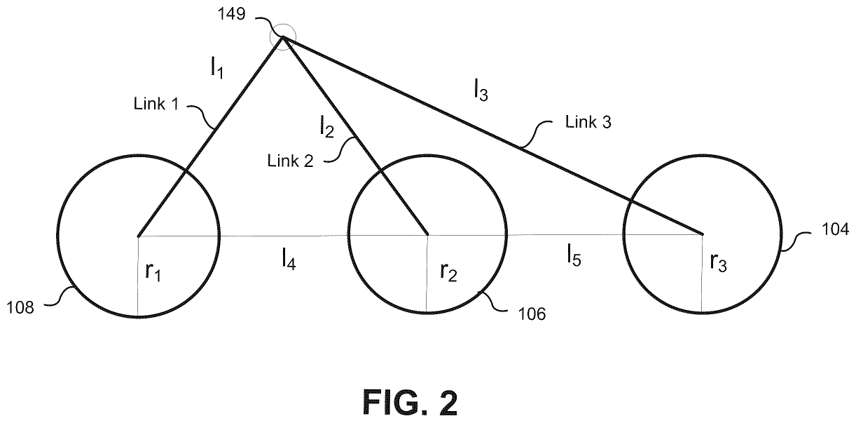

The frame structure 102 generally comprises a front section, a middle section and a rear section. It should be understood that the terms “front”, “middle”, and “rear” are used to illustrate the relative positions of the components in the direction of movement of the mobile robot 100. The relationship of the positions of the front, middle and rear wheels will be further explained in more detail with reference to FIG. 2.

The mobile robot 100 comprises at least two back wheels 104 arranged or positioned in or to the rear section of the frame structure 102, at least two middle wheels 106 arranged or positioned in or to the middle section of the frame structure 102, and at least two front wheels 108 arranged or positioned in or to the front section of the frame structure 102. Each pair of the front, middle and rear wheels 104, 106, 108 can be connected by a respective axle or individual axles (not shown).

It should be understood that while exemplary examples of the description show standalone wheels, each of one or more wheels may be part of a wheel assembly itself. For example, the wheel assembly can include more than one wheel, such as one driving wheel, and one or more supporting wheels.

The mobile device 100 also comprises a first and second front rocker arms 120 positioned on opposing sides of the frame structure 102. In accordance with the embodiment of the description, each of the front rocker arms 120 are operably coupled to the frame structure 102. Each front rocker arm 120 acts as a tilting lever and interconnects one middle wheel 106 and one front wheel 108, forming a wheel pair 107. The front rocker arm 120 fixes the two wheels 106, 108 in relation to each other and will allow them to tilt.

Each front rocker arm 120 can include rocker arms 120a, 120b which are collectively coupled to a bearing hub 103. In one embodiment of the description, the front rocker arm 120 is operably coupled to the bearing hub 103 as a free rotating arm. The bearing hub 103 can be coupled or secured to the frame structure 102. The bearing hub 103 can include at least one lever bearing (not shown) positioned between respective axial centers of rotation 149 (FIG. 2) of the wheel pairs 107. The lever bearing allows the arrangement of the middle wheel 106, the front wheel 108 as well as the front rocker arm 120 to pivot.

According to one embodiment of the description, each of the first and second front rocker arms 120 is adapted to pivot around the lever bearing located between the respective axial centers 149 of rotation of each wheel pair 107.

As illustrated in the embodiment shown in FIG. 1, each of the pair of back wheels 104 may be connected to a back arm 105 pivotally connected to the frame structure 102.

The mobile device 100 further comprises at least one motor 130 provided for actuating one or more of the front, middle and back wheels 108, 106, 104. The at least one motor 130 can be connected to one or more controllers for controlling the functions of the motor(s) 130 to collectively or individually drive movement of the various wheels 104, 106, 108. In one exemplary example, each individual wheel 104, 106, 108 may have a respective motor 130. A pair of the motors for each pair of the front, middle, and back wheels 104, 106, 108 can be controlled by a respective controller.

It should be understood that the frame structure 102 may comprise various other components or elements attached or coupled thereto, and may further comprise external power ports for power transfer, which are omitted herein.

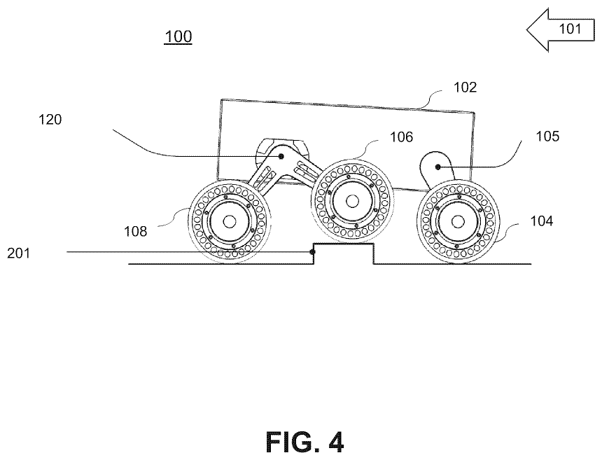

FIG. 2 illustrates a maximum allowable distance/angles between the front, middle, and back wheels 104, 106, 108 according to one embodiment of the description. With reference to FIG. 4, the relationship between the front, middle, and back wheels 104, 106, 108 can be described by the below constraints:

$$1 ) {l}_{1} + {l}_{2} \geq {l}_{4}$$

$$2 ) {r}_{i} < {l}_{i} ( i = 1 , 2 , 3 )$$

$$3 ) {r}_{1} + {r}_{2} < {l}_{4}$$

$$4 ) {l}_{3} - {r}_{3} \geq {l}_{2} + {r}_{2}$$

l_{1,2,3}: length of link 1, 2, 3
r_{1,2,3}: radius of the front, middle, back wheel
l₄: Length between the front wheel and the middle wheel
l₃: Length between the middle wheel and the back wheel

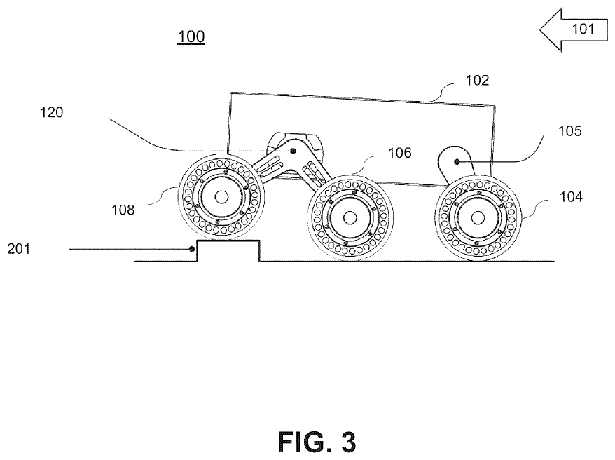

FIGS. 3 to 6 exemplify the manners in which a mobile robot 100 according to various embodiments of the description climb one or more obstacle(s).

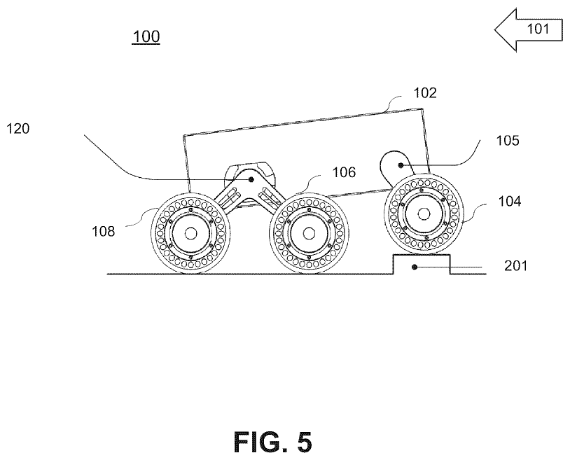

In particular, FIG. 3 shows that the mobile robot 100 encounters a vertical obstacle (e.g., step) 201 in the direction of movement 101 and starts climbing the obstacle 201 with the front wheels 108. As can be seen in FIG. 3, the use of the front rocker arms 120 and the wheel arrangement allows the front rocker arms 120 to lift and climb over the vertical obstacle 201 before the mobile robot 100 tilt, thereby providing a smoother climb. FIG. 4 shows the mobile robot 100 climbing the obstacle 201 with the middle wheels 106; and FIG. 5 shows the mobile robot 100 climbing the obstacle 201 with the back wheels 104.

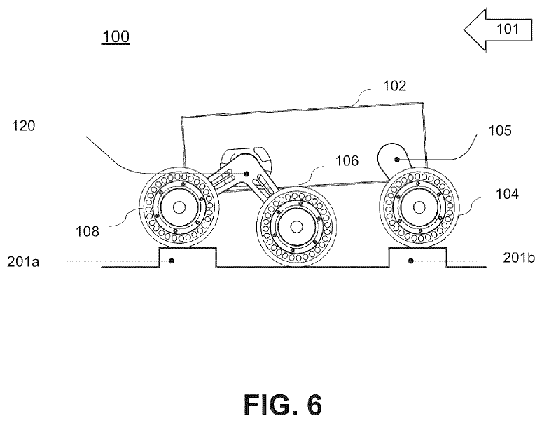

FIG. 6 shows the mobile robot 100 climbing two vertical obstacles 201a, 201b with the front wheels 108 and the back wheels 104, respectively.

According to one embodiment of the description, the robot's front rocking arms 120 can be pivoted independently of each other, which allows the left and right sides of the mobile robot 100 to independently traverse an uneven terrain. This can be particularly helpful to maintain the balance of the mobile robot 100 as it climbs over obstacles on an uneven terrain.

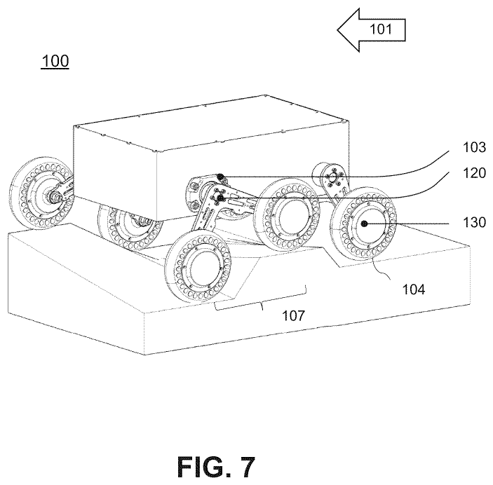

FIG. 7 shows a mobile robot 100 pivoting the left and right side front rocker arms 120 independently, according to one embodiment of the description. As shown in FIG. 7, the mobile robot 100 encounters an area where the left and right sides are uneven with respect to each other. The mobile robot 100 according to the embodiment is adapted to pivot a first front rocker arm on the left side independently from a second front rocker arm on the right side, thereby enabling the mobile robot 100 to traverse the uneven terrain more stably and effectively.

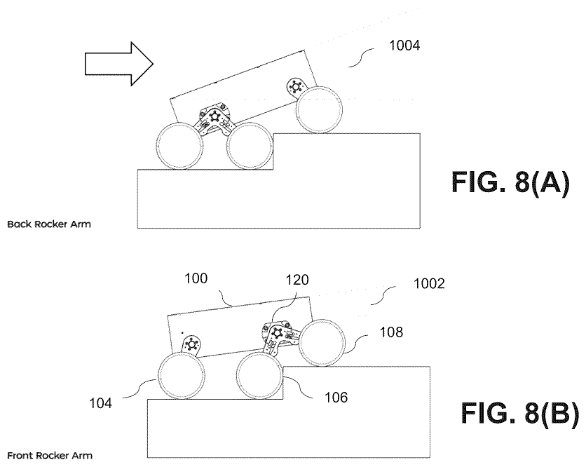

FIG. 8(A) shows a mobile robot with a back rocker arm climbing an obstacle; and FIG. 8(B) shows a mobile robot with a front rocker arm climbing an obstacle, according to one embodiment of the description.

As shown in comparison between FIGS. 8(A) and 8(B), the mobile robot 100 according to various embodiments of the description with the front rocker arms 120 maintains stability of the mobile robot better than a mobile robot using back rocker arms. The tilting angle, or attack angle 1004 of the robot can be much more significant with the use of a back rocker arm than the tilting angle 1002 with the use of a front rocker arm. The front rocker arm(s) according to the various embodiments of the description allows it to rotate before the robot, thereby absorbing the rotation before the robot reaches the obstacle and allowing a much smaller tilting angle of the robot. This arrangement can reduce the rocking movement of the frame structure 102, which is particularly important for stability of goods and objects carried in the mobile robot 100, such as by a last mile delivery robot.

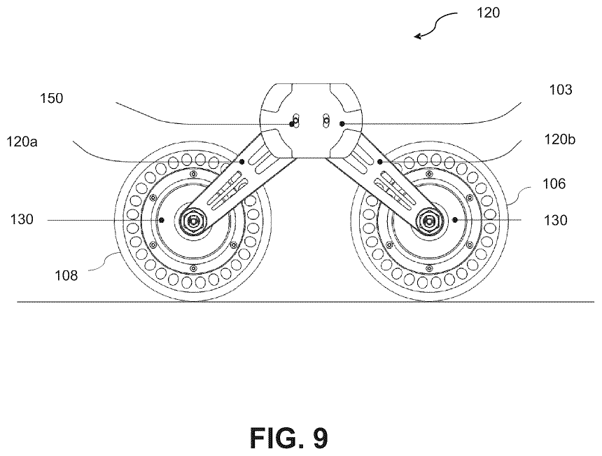

FIG. 9 shows the rocker arm assembly, according to one embodiment of the description.

According to the embodiment of the description as shown in FIG. 9, the mobile robot 100 may further include a locking mechanism 150 for restricting a rotation of each of the first and second front rocking arms 120. According to one specific embodiment of the description, the front rocking arm 120 can rotate or be rotated around the lever bearing 142, 144 by at most 20° clock or counter clockwise.

For example, the locking mechanism can include an internal dampening mechanism (such as a spring dampener or rubber dampener). When the front rocking arm 120 rotates, the rotation is translated to the robot and the dampening mechanism can control the degree of the rotation based on the its selected dampening power.

In some embodiments, the mobile robot 100 may further comprise sensors or cameras to detect objects around the mobile robot 100 while moving. For example, the mobile robot can include one or more sensors for detecting one or more vertical obstacles in the direction of movement. The mobile robot can also include one or more sensors adapted to detect an absolute and/or relative angular position of the front rocker arm(s).

The mobile robot 100 may comprise various computer hardware and/or software components to communicate with the sensors and/or cameras to control the motions of the various wheels. For example, the mobile robot may include a controller of the motor 130 that can be adapted to communicate with the one or more sensors, to facilitate traversing of a vertical obstacle upon a detection of pivot of the first and second front rocker arms by the one or more sensors.

The disclosed mobile robot is therefore designed for efficient traversal of vertical obstacles using the front rocker arm 120. The robot's front rocker arms 120 interconnect the middle and front wheels 106, 108, allowing the robot to tilt its front end up and over vertical obstacles. The back wheels 104 of the robot can provide traction and stability as the robot climbs over obstacles. The robot's lever bearings are positioned between the respective axial centers 149 of rotation of each wheel pair 107, which helps to distribute the robot's weight evenly and to reduce friction as the robot's wheels tilt.

According to the embodiments of the description, the arrangement of the mobile robot with the front rocker arm 120 can provide an cost effective suspension system for the robot without use of conventional coils to act as vibration adaptors, thereby allowing the mobile robot to have a six-wheel drive and to climb obstacles with more ease and stability.

Compared to conventional methods where some of the wheels can become free when climbing an obstacle, thereby losing contact of the wheel with the ground, various embodiments of the description can provide a better engagement of at least one wheel with the ground at all time when climbing the obstacle.

While the various embodiments of the description show a passive pivotable front arm 120, the front arm 120 may be turned with the use of an actuation mechanism. Further, when the robot 100 encounters a vertical obstacle along its direction of movement, a downward and/or upward force can be applied by the motor through the front wheels and/or the middle wheels, to facilitate the traversal of the vehicle across the vertical obstacle.

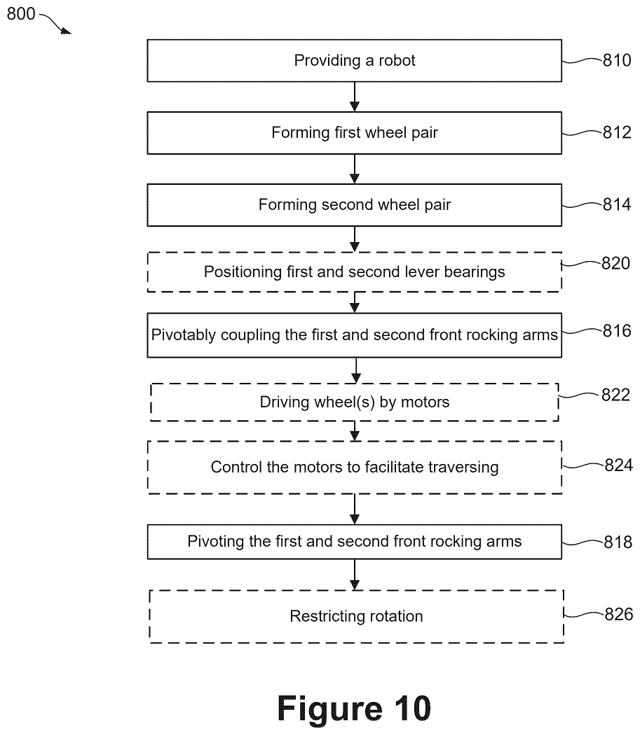

FIG. 10 is a flowchart of a method 800 according to some embodiments of the description.

The method (800) comprises providing (810) a mobile robot comprising a frame structure and a wheel assembly including at least two back wheels, at least two middle wheels, and at least two front wheels. A first middle wheel and a first front wheel are connected by a first front rocking arm, forming (812) a first wheel pair; and a second middle wheel and a second front wheel are connected by a second front rocking arm, forming (814) a second wheel pair. The method (800) further comprises arranging the first and the second front rocking arms on opposing sides of the frame structure and pivotably coupling (816) each of the first and the second front rocking arms to the frame structure. When traversing a vertical obstacle, the method comprises pivoting (818) the first and second front rocking arms around respective axial centers of rotation of the first and second wheel pairs.

In some embodiments, pivoting the first and second front rocking arms may comprise independently pivoting the first and second front rocking arms.

In some embodiments, pivoting the first and second front rocking arms may comprise pivoting each of the first and second front rocking arms by at most 20° clock or counter-clock wise.

In some embodiments, the method (800) may further comprise positioning (820) a first and second lever bearings between the respective axial centers of rotation of the first and second wheel pairs on opposing sides.

In some embodiments, the method (800) may comprise restricting (826) a rotation of each of the first and second front rocking arms by a locking mechanism.

In some embodiments, the method (800) may comprise driving (822) one or more of the front, middle and back wheels by one or more motors. The one or more motors may be controlled (824) to facilitate traversing of a vertical obstacle upon a detection of pivot of the first and second front rocking arms.

The described embodiments of the description provide a novel wheel configuration including at least one front rocker arm. The mobile robot can be used for various applications such as carrying payloads, moving objects over terrains, etc. The described mobile robot according to various embodiments is therefore adapted to navigate and climb vertical obstacles seamlessly and effectively, which is particularly important when the robots are used for delivery so that the robots can maintain their stability better while traversing the pathways, particularly in the presence of terrain fluctuation.

The mobile robots according to the description can be used in various commercial products, services, and industries, including but not limited to:

Delivery and Logistics: The described mobile robots can be used for autonomous delivery services to enhance the ability of their robots to deliver packages to homes and businesses. The robot's capability to surmount curbs and steps would enable smoother and more efficient deliveries.

Construction and Infrastructure Inspection: The described mobile robots could be used by construction and inspection companies to navigate construction sites and inspect infrastructure like bridges and pipelines. Their abilities to traverse uneven terrain and obstacles would make it a valuable tool for data collection and inspection.

Agriculture and Farming: Agricultural robots could be equipped with this technology to autonomously navigate fields and orchards, even in challenging terrain. They could perform tasks such as crop monitoring, pesticide application, and harvesting.

Search and Rescue: Search and rescue organizations could deploy the described mobile robots in disaster-stricken areas to search for survivors in debris or rubble. The robot's ability to handle uneven terrain and obstacles would be invaluable in locating and assisting victims.

Mining and Exploration: The described robots could assist in remote surveying and sample collection in rugged terrains or underground environments in mining and geological exploration.

Military and Defense: These robots may be used in military applications for reconnaissance, surveillance, or logistics support in challenging battlefield conditions.

It should be understood that the specific applications of the mobile robot 100 would depend on the design and capabilities of the mobile robot and while specific uses have been described the mobile robot 100 can be adapted to be used in other applications with uneven terrain and/or vertical obstacles.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g., “such as”) is intended merely to better illustrate or describe embodiments of the disclosure and is not intended to limit the scope of the disclosure unless otherwise claimed.

Although several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A mobile robot adapted to traverse at least one vertical obstacle comprising:
a frame structure having a front section, a middle section, and a rear section;
at least two back wheels positioned in the rear section of the frame structure,
at least two middle wheels positioned in the middle section of the frame structure,
at least two front wheels positioned in the front section of the frame structure; and
a first and a second front rocking arms arranged on opposing sides of the frame structure each pivotably coupled to the frame structure, wherein the first and second front rocking arms each interconnects one middle wheel and one front wheel, forming a first wheel pair and a second wheel pair,
wherein each of the first and second front rocking arms is pivotable around respective axial centers of rotation of the first and second wheel pairs.

2. The mobile robot of claim 1, wherein the first and the second front rocker arms are pivotable independently of each other.

3. The mobile robot of claim 1, wherein each of the first and second front rocking arms is pivotable around a lever bearing located between the respective axial centers of rotation of the first and second wheel pairs.

4. The mobile robot of claim 1, further comprising a locking mechanism for restricting a rotation of each of the first and second front rocker arms.

5. The mobile robot of claim 1, wherein each of the first and second front rocking arms is adapted to rotate around the lever bearing by at most 20° clock or counter-clock wise.

6. The mobile robot of claim 1, further comprising one or more motors driving one or more of the front, middle and back wheels.

7. The mobile robot of claim 6, wherein the one or more motors are adapted to facilitate traversing of the at least one vertical obstacle upon a detection of pivot of the first and second front rocker arms.

8. A method comprising:
providing a mobile robot comprising a frame structure and a wheel assembly including at least two back wheels, at least two middle wheels, and at least two front wheels;
connecting a first middle wheel and a first front wheel by a first front rocking arm, forming a first wheel pair;
connecting a second middle wheel and a second front wheel by a second front rocking arm, forming a second wheel pair;
arranging the first and the second front rocking arms on opposing sides of the frame structure and pivotably coupling each of the first and the second front rocking arms to the frame structure, and
when traversing a vertical obstacle pivoting the first and second front rocking arms around respective axial centers of rotation of the first and second wheel pairs.

9. The method according to claim 8, wherein pivoting the first and second front rocking arms comprises independently pivoting the first and second front rocking arms.

10. The method according to claim 8, further comprising:
positioning a first and second lever bearings between the respective axial centers of rotation of the first and second wheel pairs on opposing sides.

11. The method according to claim 8, further comprising restricting a rotation of each of the first and second front rocking arms by a locking mechanism.

12. The method according to claim 8, wherein pivoting the first and second front rocking arms comprises pivoting each of the first and second front rocking arms by at most 20° clock or counter-clock wise.

13. The method according to claim 8, further comprising driving one or more of the front, middle and back wheels by one or more motors.

14. The method according to claim 13, further comprising controlling the one or more motors to facilitate traversing of a vertical obstacle upon a detection of pivot of the first and second front rocking arms.
